(19) United States
(12) Patent Application Publication
(10) Pub. No.: US 2018/0105777 A1
(43) Pub. Date: Apr. 19, 2018

(54) BEER COMPOSITION AND METHOD OF MAKING SAME

(71) Applicant: Sleeman Breweries Ltd., Guelph (CA)

(72) Inventors: Ed McCallum, Guelph, Ontario (CA); Chris Williams, Guelph, Ontario (CA); Stephane Duval, Guelph, Ontario (CA)

(21) Appl. No.: 15/567,285

(22) PCT Filed: May 4, 2016
(86) PCT No.: PCT/CA2016/050512

§ 371 Date: Oct. 17, 2017

Related U.S. Application Data
(60) Provisional application No. 62/158,184, filed on May 7, 2015.

(51) Int. Cl. C12C 5/02; C12C 11/11; C12C 12/00

(52) U.S. Cl. CPC C12C 5/02; C12C 11/11; C12C 12/00; A23V 2250/1614; A23V 2200/33; A23V 2250/21; A23V 2002/00

(57) ABSTRACT

A beer composition including a hydration additive is described. The hydration additive includes a coconut extract and a salt additive. The beer composition may provide a hydrating effect or a feeling of hydration upon consumption. The coconut extract may be in the form of a frozen coconut concentrate that can be diluted with water to form a coconut solution. The coconut solution may be added during the brewing process together with the salt additive in a mixture or may be added separately or sequentially. Typically, the salt additive is in the form of sodium chloride and may contain other optional salts.

### FIELD OF THE INVENTION

The invention relates to beer compositions and more specifically to beer compositions that include a hydration additive and processes for making beer compositions that include a hydration additive.

### BACKGROUND

During strenuous exercise or sporting activity, humans lose water and salts by sweating and expending energy. Some examples of salts that are lost are sodium, potassium, calcium and magnesium. Maintaining a balance of these salts is essential for normal function of the body. Exercise or other strenuous activities that cause sweating can result in dehydration and a shift of the salt balance. The body does not naturally produce water and salts. Therefore, the lost water and salts must be replaced by rehydrating with water or food.

Beer is a part of social interaction including interactions at and during sporting activities. However, beer does not contain enough salts to sufficiently replenish the ones lost and the effect of dehydration can be prolonged.

There is therefore a need for a beer composition that can provide a feeling of hydration and/or that may replenish the essential constituents lost during exercise.

### SUMMARY OF THE INVENTION

A beer composition comprising a hydration additive which includes a coconut extract and a salt additive is provided. The coconut extract may be in the form of a frozen coconut concentrate that can be diluted with water to form a coconut solution. This coconut solution may be added during the brewing process together with the salt additive in a mixture or may be added separately or sequentially. Optionally, the salt additive is in the form of sodium chloride and may contain other optional salts.

In one embodiment, the invention provides for a beer composition comprising a hydration additive, the hydration additive comprising:
a coconut extract; and
a salt additive.

In another embodiment of the beer composition or compositions as outlined above, the coconut extract is a frozen coconut concentrate.

In another embodiment of the beer composition or compositions as outlined above, the coconut extract is diluted with water to form a coconut solution.

In another embodiment of the beer composition or compositions as outlined above, the coconut extract is diluted to from about 50% to about 100% of the concentration of a natural coconut water to form the coconut solution.

In another embodiment of the beer composition or compositions as outlined above, the salt additive comprises sodium.

In another embodiment of the beer composition or compositions as outlined above, the salt additive further comprises potassium, calcium, magnesium, or a combination thereof.

In another embodiment of the beer composition or compositions as outlined above, the salt additive is added in an amount to bring the total sodium content of the beer composition to an amount of about 4-5% of a daily recommended intake value per 12 ounces.

In another embodiment of the beer composition or compositions as outlined above, the salt additive is added in an amount to bring the total sodium content of the beer composition to an amount of from about 110 mg to about 115 mg per 12 ounces.

In another embodiment of the beer composition or compositions as outlined above, the coconut solution is present in an amount of from 1 to 15% v/v.

In another embodiment of the beer composition or compositions as outlined above, the coconut solution is present in an amount of from 1 to 10% v/v.

In another embodiment of the beer composition or compositions as outlined above, the coconut solution is present in an amount of from 1 to 5% v/v.

In another embodiment of the beer composition or compositions as outlined above, the coconut solution is present in an amount of from 1 to 2% v/v.

In another embodiment of the beer composition or compositions as outlined above, the coconut solution is present in an amount of from 2 to 5% v/v.

In a further embodiment, the invention provides for a process for producing a beer composition comprising a hydration additive, the process comprising:
a) mashing a grain bill to produce a sweet wort liquid;
b) boiling the sweet wort liquid with hops to produce a wort;
c) fermenting the wort to produce a beer; and
d) mixing the beer with the hydration additive to produce the beer composition.

In another embodiment of the process or processes for producing a beer as outlined above, in step d) the hydration additive comprises a coconut extract and a salt additive which are added separately, sequentially or as a combined mixture.

In another embodiment of the process or processes for producing a beer as outlined above, the hydration additive is as defined herein.

In a yet further embodiment, the invention provides for a beer composition comprising:
alcohol in an amount of about 4% ABV,
about 1% v/v coconut solution,
about 115 mg/355 ml sodium,
about 95 mg/355 ml potassium,
about 22 mg/355 ml calcium, and
about 25 mg/355 ml magnesium.

In an even yet further embodiment, the invention provides for a beer composition comprising:
alcohol in an amount of about 4% ABV,
about 1% v/v coconut solution,
about 110 mg/341 ml sodium,
about 91 mg/341 ml potassium,
about 21 mg/341 ml calcium, and
about 24 mg/341 ml magnesium.

In another embodiment of the beer composition or compositions as outlined above, the coconut solution is produced from a frozen coconut concentrate diluted with water to from about 50% to about 100% of the concentration of a natural coconut water.

In another embodiment of the beer composition or compositions as outlined above, the coconut solution is produced from a frozen coconut concentrate diluted to about 100% of the concentration of a natural coconut water.

### BRIEF DESCRIPTION OF DRAWINGS

FIG. 1 is an illustrative flowchart of one embodiment of a process for producing a beer composition comprising one embodiment of a hydration additive;

FIG. 2 is a illustrative flowchart of another embodiment of a process for producing a beer composition comprising one embodiment of a hydration additive.

### DETAILED DESCRIPTION

Described herein are embodiments of processes suitable for producing a beer composition comprising a hydration additive as well as embodiments of beer compositions which comprise a hydration additive. It will be appreciated that the processes, compositions and embodiments described herein are for illustrative purposes intended for those skilled in the art and are not meant to be limiting in any way. All reference to capacities, embodiments or examples throughout this disclosure, including the Figures, should be considered a reference to an illustrative and non-limiting embodiment or an illustrative and non-limiting example.

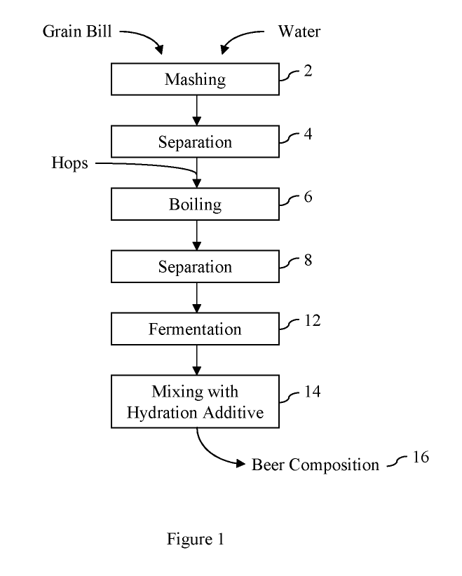

FIG. 1 is a flowchart illustrating one example of a process for producing embodiments of a beer composition comprising a hydration additive. In a mashing step 2, a grain bill is mixed with water and mashed at a controlled temperature to produce a sweet wort liquid and a residual grain. Mashing 2 may be carried out, for example, in a mashing tun. The sweet wort liquid is then separated in a separation step 4 from the residual grain to produce a separated sweet wort liquid. In one embodiment, separation 4 may be carried out in a lauter tun. The sweet wort liquid is combined with hops and is boiled, in a boiling step 6. Boiling 6 may be performed, for example, in a copper. Boiling produces a trub and wort which may be separated in a further separation step 8. In one embodiment, further separation 8 may be carried out in a whirlpool tank. After further separation 8 of the protein trub, the wort is fermented with the addition of oxygen and yeast in a fermentation step 12. Fermentation 12 may be carried out, for example, in a fermentation tank. It will be appreciated that fermentation may take place using an alternative to adding yeast. The resulting fermented composition is mixed with a hydration additive in a mixing step 14 to produce a beer composition 16 which may provide a hydration effect or feeling of hydration upon consumption. The hydration additive can include various amounts of a coconut extract, typically in the form of a coconut solution, for example from a frozen coconut concentrate and one or more optional additional salts, typically in the form of sodium chloride. However, it will be appreciated, that other optional salts such as potassium, magnesium and calcium may be included based, for example, on the type of feed water used in the process. In one example, sodium is added in an amount sufficient to provide about 5% of the daily recommended intake in a single bottle or can of the beer composition. As will be outlined below in further detail, the amount of coconut solution may be optimized or adjusted to enhance optical clarity and avoid, reduce or minimize haziness in the beer composition that is at least partly due to proteins and carbohydrates present in the coconut extract. This is especially important once the beer is bottled to ensure the bottled beer appears clear and appetizing and to potentially avoid certain or unwanted taste profiles.

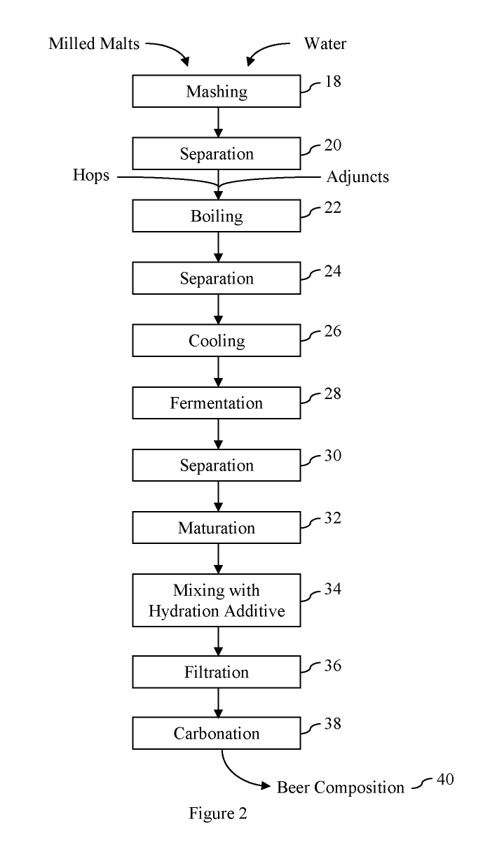

FIG. 2 is a flowchart illustrating another example of a process for producing embodiments of a beer composition comprising a hydration additive. In a mashing step 18, milled malts (for example 4800 kg), calcium salts including calcium chloride and calcium sulphate (for example 40 kg) are mixed with water for mashing at controlled temperatures ranging from, for example, about 35° C. to about 78° C. to produce a sweet wort liquid and residual grain. Mashing 18 may be carried out, for example, in a mashing tun. The sweet wort liquid is then separated in a separation step 20 from the residual grain to produce a separated sweet wort liquid. In one embodiment, separation 20 may be carried out in a lauter tun. The sweet wort liquid is combined with hops (for example 15 kg), hop extracts and/or a derivative thereof, and an adjunct (for example 2000 kg) and is boiled in a boiling step 22 from, for example, about 60 minutes to about 90 minutes. An example of the adjunct is refined high maltose corn syrup. Boiling may be performed, for example, in a copper. Boiling produces a trub and wort which are separated in a further separation step 24. In one embodiment, further separation 24 may be carried out in a whirlpool tank. After further separation 24 of the trub, the wort is cooled in a cooling step 26, for example, to about 14° C., to produce a cooled wort. The cooling 26 may be performed, for example, with a plate heat exchanger. The cooled wort is fermented in a fermentation step 28 with the addition of oxygen and yeast, for example, at about 15° C. for about 7 to about 10 days to produce a beer and a protein trub. The protein trub is separated from the beer in another separation step 30. The separated beer is matured in a maturation step 32, for example, at about 0° C., generally for a minimum of about 7 days to enhance the taste of the beer. A hydration additive is added and mixed in a mixing step 34 with the mature beer to produce a beer composition. In one example, about 40 kg to about 80 kg of a hydration additive may be mixed with the beer. To form the hydration additive, a coconut solution, for example in the form of a frozen coconut concentrate, is mixed with deaerated water and a salt additive, usually in the form of sodium chloride. This mixture is then added to the mature beer. The frozen coconut concentrate may be diluted with the deaerated water to from about 50% to about 100% of the concentration of natural coconut water. It will be appreciated that the salt may be mixed with the coconut solution, or alternatively, may be added separately from or sequentially with the coconut solution and may be added in a diluted or dissolved form. The beer composition is filtered in a filtration step 36. The filtration 36 may be performed, for example, in a diatomaceous earth candle filter. The beer composition may be maintained, for example, at about −1° C. throughout the filtration step 36 in order to maintain physical stability. Additional deaerated water may be added as needed to adjust the alcohol content to from about 0.5% v/v to about 8% v/v, and optionally to about 4% v/v. The beer composition is carbonated in a carbonation step 38, for example, to about 2.7% v/v carbon dioxide prior to filling in kegs, cans or bottles.

It will be appreciated that the step of adding and mixing a hydration additive with the mature beer to produce a beer composition before filtration may be incorporated into other beer brewing processes. It is not intended that the addition and mixing of a hydration additive is limited to only those brewing processes disclosed herein. The brewing processes disclosed herein are merely illustrative of various processes to which a hydration additive may be added and mixed in the process of brewing a beer. The hydration additive referred to herein is intended to encompass both a combination of a coconut extract or coconut solution mixed with a salt additive both before addition to the beer and also captures sequential or separate addition of the hydration additive and the salt additive.

In one embodiment, the beer composition may have between 1 to 2% v/v of the coconut solution. It will be appreciated, that other suitable amounts of the coconut solution may be added to the beer to produce a beer composition without deteriorating the optical clarity. For example, in one embodiment, the beer composition may have less than 15% v/v of the coconut solution. In another embodiment, the beer composition may have between 1 to 10% v/v of the coconut solution. In yet another embodiment, the beer composition may have between 1 to 5% v/v of the coconut solution. In another embodiment, the beer composition may have between 2 to 5% v/v of the coconut solution. It has been determined that beer compositions having an amount of the coconut solution of 15% v/v or higher have reduced optical clarity as shown in Table 3, which outlines the haze value at time of packaging of a beer composition following a forcing test and will be outlined below.

A typical beer may comprise, for example, about 25-60 ppm of sodium, about 200-500 ppm of potassium, about 30-75 ppm of calcium and about 50-120 ppm of magnesium before addition of a hydration additive. In one example of a beer composition, the salt additive in the hydration additive may contribute an additional amount of sodium to produce a beer that provides about 5% of the daily recommended intake of sodium (about 115 mg/355 ml or about 110 mg/341 ml). Based on the amount of the coconut solution used in the hydration additive, the coconut solution may contribute up to nearly about 75 ppm of sodium, about 227 ppm of potassium, about 13 ppm of calcium and about 15 ppm of magnesium. The higher end of these ranges can result in some haziness in the beer as will be outlined below with reference to Table 3. In a further embodiment, the coconut solution of the hydration additive may contribute an additional amount of up to about 50 ppm of sodium, up to about 152 ppm of potassium, up about 9 ppm of calcium and/or up to about 10 ppm of magnesium. Preferably, these salt amounts will not contribute to haze in a beer composition which is considered unsuitable.

### Example 1

The following is an example of a beer composition produced by the methods such as outlined herein comprising various amounts of a coconut solution. In the example, the coconut solution is in particular a frozen coconut concentrate diluted with water to about 100% of the concentration of natural coconut water. Table 1 depicts the amounts of sodium, potassium, calcium and magnesium salts in one embodiment of a coconut solution.

TABLE 1

| Amount of Coconut | | | | |
|---|---|---|---|---|
| Solution in Beer | Amount of Individual Salts in Coconut Solution | | | |
| Composition | (ppm) | | | |
| (% v/v) | Sodium | Potassium | Calcium | Magnesium |
| 0 | 0 | 0 | 0 | 0 |
| 1 | 5 | 15 | 1 | 1 |
| 2 | 10 | 30 | 2 | 2 |
| 5 | 25 | 76 | 4 | 5 |
| 10 | 50 | 152 | 9 | 10 |
| 15 | 75 | 227 | 13 | 15 |
| 20 | 100 | 303 | 18 | 20 |
| 30 | 150 | 455 | 26 | 30 |

### Example 2

The following is an example of a beer composition produced by methods, such as those outlined herein, comprising various amounts of one embodiment of a hydration additive. In the example, the hydration additive is a coconut solution and in particular a frozen coconut concentrate diluted to about 100% of the concentration of natural coconut water. Table 2 depicts the total amounts of sodium, potassium, calcium and magnesium salts in various embodiments of examples of a beer composition. These beer compositions were later tested to determine their haze values as shown in Table 3.

TABLE 2

| Amount of Coconut | | | | |
|---|---|---|---|---|
| Solution in Beer | Amount of Total Individual Salts in Beer | | | |
| Composition | Composition (ppm) | | | |
| (% v/v) | Sodium | Potassium | Calcium | Magnesium |
| 0 | 280 | 220 | 63 | 66 |
| 1 | 285 | 235 | 64 | 67 |
| 2 | 290 | 250 | 65 | 68 |
| 5 | 305 | 296 | 67 | 71 |
| 10 | 330 | 372 | 72 | 76 |
| 15 | 355 | 447 | 76 | 81 |
| 20 | 380 | 523 | 81 | 86 |
| 30 | 430 | 675 | 89 | 96 |

### Example 3

It has been determined that the addition of excess coconut solution to a beer composition can diminish the optical clarity of the beer composition through the formation of a haze. It is believed that this haze is at least partially attributed to the protein and carbohydrates found in the coconut solution. As shown in Table 3, haze can become apparent when 15% v/v or more of the coconut solution, in this case, frozen coconut concentrate diluted to about 100% of the concentration of natural coconut water, is added to the beer composition. As many beer compositions are stored in clear bottles, a consumer may have a tendency to purchase products that have a clear composition as opposed to products that have a visible haze. Studies have shown, as will be presented by Table 3 herein, that the balance of the coconut solution and salts in the beer composition can be crucial for the final clarity of the beer. The addition of a large amount of a hydration additive to a beer composition can result in visible haze in the bottle. Therefore, there should be a balance between the amount of a hydration additive and the amount of haze in the beer composition.

The following example depicts forcing test results performed on a beer composition comprising various amounts of a coconut solution to determine if the beer composition will be stable for a longer period of time, for example three months. In the example, the hydration additive is a coconut solution and in particular a frozen coconut concentrate diluted with deaerated water to about 100% of the concentration of natural coconut water. Table 3 presents the haze values at time of packaging and after a forcing test in ASBC (American Society of Brewing Chemists) units. The forcing test conducted involved heating a beer composition in a bottle at time of packaging at 60° C. for 72 hours, followed by cooling to 0-3° C. for 24 hours. The haze values were determined by a Hache™ turbidity meter. These forcing test conditions allow the reproduction of the beer composition haze as would be seen with the beer composition after three months. It will be appreciated that even without the addition of any coconut extract there is a minimal amount of haze which, it is believed, is at least partially due to the hops and yeast included in the brewing process.

TABLE 3

| Amount of Coconut | | |
|---|---|---|
| Solution in Beer | Haze Value at Time | Haze Value after |
| Composition | of Packaging | Forcing Test |
| (% v/v) | (ASBC units) | (ASBC units) |
| 0 | 28 | 47 |
| 1 | 36 | 80 |
| 2 | 44 | 114 |
| 5 | 71 | 207 |
| 10 | 125 | 213 |
| 15 | 168 | 250 |
| 20 | 236 | 283 |
| 30 | 347 | 451 |

A haze value greater than 150 ASBC units at time of packaging and greater than 250 ASBC units upon completion of the forcing test is generally considered unsuitable as the product may generally be viewed as being overly hazy, which may generate negative connotations associated with a hazy beer. The haze would be visible to the unaided eye above 250 ASBC units. It is apparent that at these conditions, the haze values wherein the amount of a coconut solution is at or more than 15% v/v are generally considered unacceptable.

It will be appreciated that use of the term “about” as used herein is intended to capture any error associated with the measurements used in relation to the range or amount associated to the term, including both human error and instrumental error and also includes typical fluctuations in the distribution of concentrations throughout a volume. It will also be appreciated that the term “about” can apply to the ranges outlined herein, as various food and drug governing bodies require rounding of the amounts of ingredients or contents of products, including rounding to the nearest fifth or tenth. It is intended for the use of the term “about” to capture such adjustments.

It will be appreciated that modifications, amendments and/or alterations to the processes and compositions described herein may be carried out and are intended to be within the scope and spirit of the invention.

1: A beer composition comprising a hydration additive, the hydration additive comprising:
a coconut extract; and
a salt additive.

2: The beer composition of claim 1, wherein the coconut extract is a frozen coconut concentrate.

3: The beer composition of claim 1, wherein the coconut extract is diluted with water to form a coconut solution.

4: The beer composition of claim 3, wherein the coconut extract is diluted to from about 50% to about 100% of the concentration of a natural coconut water to form the coconut solution.

5: The beer composition of claim 1, wherein the salt additive comprises sodium.

6: The beer composition of claim 5, wherein the salt additive further comprises potassium, calcium, magnesium, or a combination thereof.

7: The beer composition of claim 1, wherein the salt additive is added in an amount to bring a total sodium content of the beer composition to an amount of about 4-5% of a daily recommended intake value per 12 ounces.

8: The beer composition of claim 1, wherein the salt additive is added in an amount to bring a total sodium content of the beer composition to an amount of from about 110 mg to about 115 mg per 12 ounces.

9: The beer composition of claim 3, wherein the coconut solution is present in an amount of from 1 to 15% v/v.

10: The beer composition of claim 3, wherein the coconut solution is present in an amount of from 1 to 10% v/v.

11: The beer composition of claim 3, wherein the coconut solution is present in an amount of from 1 to 5% v/v.

12: The beer composition of claim 3, wherein the coconut solution is present in an amount of from 1 to 2% v/v.

13: The beer composition of claim 3, wherein the coconut solution is present in an amount of from 2 to 5% v/v.

14: A process for producing a beer composition comprising a hydration additive, the process comprising:
a) mashing a grain bill to produce a sweet wort liquid;
b) boiling the sweet wort liquid with hops to produce a wort;
c) fermenting the wort to produce a beer; and
d) mixing the beer with the hydration additive to produce the beer composition.

15: The process of claim 14, wherein in step d) the hydration additive comprises a coconut extract and a salt additive which are added separately, sequentially or as a combined mixture.

16: The process of claim 14, wherein the hydration additive includes:
a coconut extract, and
a salt additive.

17: A beer composition comprising:
alcohol in an amount of about 4% ABV,
about 1% v/v coconut solution,
about 115 mg/355 ml sodium,
about 95 mg/355 ml potassium,
about 22 mg/355 ml calcium, and
about 25 mg/355 ml magnesium.

18: A beer composition comprising:
alcohol in an amount of about 4% ABV,
about 1% v/v coconut solution,
about 110 mg/341 ml sodium,
about 91 mg/341 ml potassium,
about 21 mg/341 ml calcium, and
about 24 mg/341 ml magnesium.

19: The beer composition of claim 17, wherein the coconut solution is produced from a frozen coconut concentrate diluted with water to from about 50% to about 100% of the concentration of a natural coconut water.

20: The beer composition of claim 17, wherein the coconut solution is produced from a frozen coconut concentrate diluted to about 100% of the concentration of a natural coconut water.
